(19) United States
(12) Patent Application Publication
(10) Pub. No.: US 2024/0040475 A1
(43) Pub. Date: Feb. 1, 2024

(54) METHOD FOR ACQUIRING TELECOMMUNICATION REGULATIONS AND SYSTEM APPLYING THE SAME

(71) Applicant: REALTEK SEMICONDUCTOR CORP., HSINCHU (TW)

(72) Inventors: JIUN-LE WU, HSINCHU (TW); TING-YAO CHIU, HSINCHU (TW)

(21) Appl. No.: 18/359,027

(22) Filed: Jul. 26, 2023

(30) Foreign Application Priority Data
Jul. 27, 2022 (TW) 111128052

(51) Int. Cl. H04W 48/04; H04W 64/00

(52) U.S. Cl. CPC H04W 48/04; H04W 64/00

(57) ABSTRACT

A method for acquiring telecommunication regulations and a system applying the same are provided. The method allows a wireless communication device to acquire the telecommunication regulations, and the system is applicable in the wireless communication device. In the method, a driver installed in the wireless communication device is executed to drive a wireless communication module of the wireless communication device. In the meantime, the driver can obtain location data from a BIOS or an operating system, or through environment detection. The driver uses the location data to compare the multiple telecommunication regulations recorded in program codes of the driver, so as to obtain the telecommunication regulation corresponding to the location data. Therefore, the system having the wireless communication module can operate according to the telecommunication regulation corresponding to the location data.

CROSS-REFERENCE TO RELATED PATENT APPLICATION

This application claims the benefit of priority to Taiwan Patent Application No. 111128052, filed on Jul. 27, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for determining a wireless communication regulation, and more particularly to a method for acquiring a region where a wireless communication device operates wireless transmission and a corresponding telecommunication regulation according to ambient information and a system applying the same.

### BACKGROUND OF THE DISCLOSURE

With the advancement of wireless communication technologies, various applications of wireless networks can be seen in everyday life and wireless devices are ubiquitous. The wireless devices can be mobile phones, tablets, laptop computers, and even household appliances (such as televisions, refrigerators, air conditioners, and lamps). With the development of smart appliances, traditional household appliances are gradually modernized and transformed into wireless smart household appliances.

Not only is the quantity of various wireless devices increased year by year, but a delivery range of shipments from a manufacturer thereof also covers different regions across the world. Given that telecommunication regulations vary from country to country, the wireless devices shipped to different regions should comply with the telecommunication regulations specific to that country or region. For example, a spectrum of a wireless device signal and an energy intensity for signal transmission need to comply with the corresponding regulations. Therefore, regarding production and management of wireless communication modules of the wireless devices, when a huge amount of wireless devices are exported to various countries with different telecommunication regulations, reducing the maintenance burden of stock keeping units (SKU) under different national regulations becomes an important aspect to consider.

Taking production of the wireless communication modules under the IEEE 802.11 standard as an example, the manufacturer usually has a shipping region, a regulation code and relevant configurations for the regulation burned into a memory module (e.g., an electrically programmable fuse (eFuse), an electrically erasable programmable read-only memory (EEPROM) or a flash memory) by use of a production program during a manufacturing process. Terms such as “1 lac support” or “adaptivity enable” can be labelled on the modules. Afterwards, during execution of a driver, an operator can be made aware of the present regulation according to the regulation code and the configurations that are pre-burned into the memory module.

In the conventional method of burning the codes into memory in advance, the manufacturer is required to determine the regulation code and a quantity of the corresponding wireless communication modules before production, and the production progresses after the quantity is determined. However, after the production process is complete, if an actual shipment with a specific regulation code does not meet an estimated quantity, or if the regulation is changed, the production program needs be implemented again to modify the corresponding regulation code and the configuration in this conventional method. Hence, such a method lacks flexibility and practicality in production management of the wireless communication modules, and the costs associated therewith are increased.

### SUMMARY OF THE DISCLOSURE

In order to solve the problem of changing a regulation code of a shipping region and relevant configurations of a wireless communication module in a wireless device that are pre-burned into a memory, the present disclosure provides a method for acquiring telecommunication regulations and a system applying the same. In the method, the wireless communication module can use a single stock keeping unit (SKU) for production and shipment, and it is no longer necessary to pre-burn the regulations of different shipping regions. Therefore, the method allows the production management to be simplified and more flexible.

According to one embodiment of the present disclosure, in the method for acquiring the telecommunication regulations, a driver is executed for driving a wireless communication module. Then, the driver uses location data to compare the multiple telecommunication regulations recorded in program codes of the driver, so as to acquire the telecommunication regulation corresponding to the location data. Therefore, the system having the wireless communication module can operate according to the telecommunication regulation corresponding to the location data.

Preferably, the system is operated in a wireless communication device, and the location data includes a country code or an area code that can be stored into a BIOS or an operating system of the wireless communication device.

Further, the location data can be obtained by scanning beacon signals generated by one or more access points in an environment of the system. The system scans the one or more access points with different frequency bands in an active manner or in a passive manner. When multiple pieces of the location data are obtained by scanning the beacon signals generated by the multiple access points, one of the multiple pieces of the location data can be decided by a statistical method or based on a selection strategy.

According to one embodiment of the system that applies the above-mentioned method, the system includes the wireless communication module and the memory. The memory is used to store the driver of the wireless communication module and the program codes. When the system is booted, the operating system executes the driver for driving the wireless communication module to operate. The driver can be used to perform the method for acquiring the telecommunication regulations.

In one further embodiment of the method for acquiring the telecommunication regulations, after the driver is activated, the system enters a system SKU check phase. In the system SKU check phase, the BIOS is checked for determining whether or not the location data is present. If the location data is present in the BIOS, the corresponding telecommunication regulation is queried according to the location data. If the location data is not present in the BIOS, the system enters a supplementary check phase. In the supplementary check phase, system information is checked for determining whether or not the location data is present. If the location data is present in the system information, the corresponding telecommunication regulation is queried according to the location data. Conversely, if the location data is not present in the system information, the system enters an environmental check phase. In the environmental check phase, the driver actively or passively scans the beacon signals generated by the one or more access points in the environment where the system is located for checking whether or not the location data is present. If the location data is present in the beacon signals, the corresponding telecommunication regulation is queried according to the location data. Finally, the system having the wireless communication module can operate according to the telecommunication regulation corresponding to the location data.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram showing a system framework that applies a method for acquiring telecommunication regulations according to one embodiment of the present disclosure;

FIG. 2 is a flowchart illustrating the method for acquiring the telecommunication regulations according to one embodiment of the present disclosure;

FIG. 3 is a schematic diagram showing a network environment that applies the method for acquiring the telecommunication regulations according to one embodiment of the present disclosure;

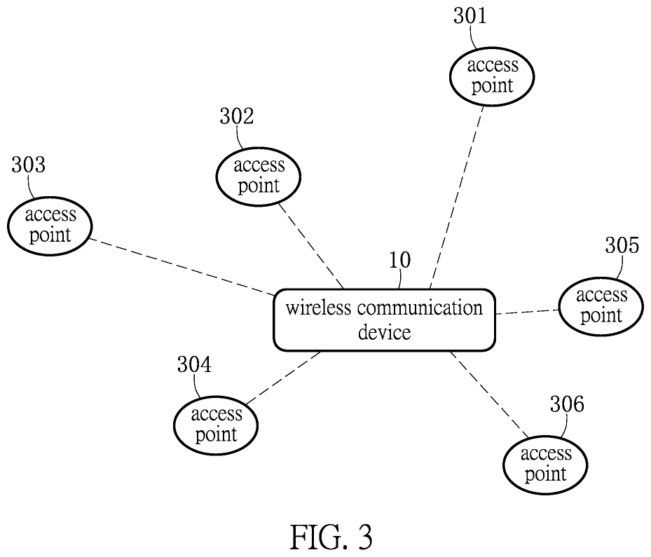

FIG. 4 is a flowchart illustrating the method for acquiring the telecommunication regulations by environment scanning according to one embodiment of the present disclosure; and

FIG. 5 is a flowchart illustrating the method for acquiring the telecommunication regulations according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure relates to a method for acquiring telecommunication regulations and a system applying the same. The method is primarily performed on a wireless communication module of a wireless communication device for acquiring the telecommunication regulation corresponding to a specific location where the wireless communication device is located. The wireless communication module can be communication modules in compliance with the IEEE 802.11 standard (e.g., a WIFI module and a mobile communication module). While a conventional production process requires a shipping region and a product quantity in advance, it is no longer necessary to pre-burn a regulation code of a specific wireless communication regulation that corresponds to the shipping region into a memory during a production process provided in the method of the present disclosure. One of the objectives of the method is to improve stock keeping unit (SKU) management in the production process of the wireless communication module under a specific wireless communication standard (e.g., IEEE 802.11).

According to the technical objective of the method for acquiring the telecommunication regulations, a single stock keeping unit is adopted during the production process. Further, codes and configurations corresponding to different shipping regions do not need to be pre-burned into the wireless communication module by a specific production program, nor does the product quantity for each shipping region need to be decided in advance. Thus, for the same client, production management can be performed by the same method even though the wireless communication modules are configured to be delivered to different shipping regions. When the communication regulation in any of the shipping regions is changed, the wireless communication device can still comply with the regulation of the shipping region (an area or a country) if a driver of the wireless communication device is updated (without modifying the wireless communication module through the production program). Therefore, the production management of the wireless communication module can be simplified and has great flexibility.

According to one embodiment of the method for acquiring the telecommunication regulations, the production and management of the wireless communication module can be made by a single stock keeping unit. Moreover, without modifying the hardware configuration of the wireless communication module, a proper regulation code can be selected. The hardware configuration can be parameters that include a hardware identification code, the regulation code that corresponds to the shipping region, and relevant configurations for the regulation. Accordingly, the wireless communication module can comply with the regulation of each region during wireless transmission.

For example, the regional regulations for the wireless communication device under the IEEE 802.11 standard can be divided into the following types, and such information is pre-recorded in the driver of the wireless communication device. The regulations include a channel plan that can exemplarily be “2 GHz: channel 1-14”, “5 GHz channel 36, 40, 44, 48, 52, 56, 60, 64, . . . ” or “6 GHz channels 1, 5, 9, 13, . . . ”, an IEEE 802.11 PHY layer that is compatible with 802.11 b/g/n/a/ac/ax, and supervision standards in compliance with the Federal Communications Commission (FCC), the European conformity (CE) or the Telecom Engineering Center (TELEC) that can include relevant transmission power guidelines. It should be noted that the channel plans and the IEEE 802.11 PHY layers in each of the frequency bands supported by different countries or areas may vary, and the supervision standards can also be different. However, as long as the located region is acknowledged, the wireless communication device can perform wireless transmission according to the channel plan, the physical layer configuration, and the supervision standard approved by the regional regulation.

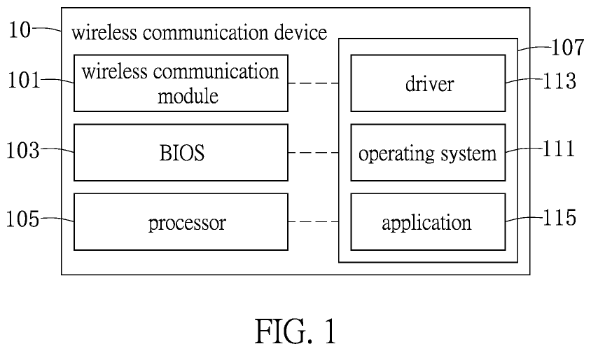

FIG. 1 is a schematic diagram showing a system framework that applies a method for acquiring telecommunication regulations according to one embodiment of the present disclosure. The system provided by the present disclosure includes hardware and software operated in a wireless communication device 10 shown in FIG. 1. The wireless communication device 10 can be a personal computer, a mobile device, a tablet computer or any electronic device with a wireless communication function. Essential components of the hardware include a processor 105, a BIOS (basic input/output system) 103 and a wireless communication module 101. The software is, for example, an operating system 111, a driver 113 for driving the wireless communication module 101 and other applications 115 operated in the system. The wireless communication device 10 includes a memory 107 that stores not only software programs of the operating system 111 and the applications 115, but also program codes of the driver 113. In particular, the program codes record telecommunication regulations of multiple regions.

When the system of the wireless communication module 101 is activated, the operating system 111 starts to operate and execute the driver 113. The driver 113 initiates the wireless communication module 101, and then drives the wireless communication module 101 to operate. The driver 113 also starts the method for acquiring the telecommunication regulations. According to one embodiment of the present disclosure, the telecommunication regulations of many regions have already been written into the driver 113. The driver 113 retrieves information of the telecommunication regulation from the BIOS 103 of the system. For example, the driver 113 retrieves a regional code from the information burned in the BIOS 103, and the corresponding telecommunication regulation can be obtained after comparing the regional code with the program codes of the driver 113. Alternatively, the driver 113 can retrieve the regional information (e.g., of a country) from the operating system 111, and acquire the corresponding telecommunication regulation after comparing the regional code with the program codes of the driver 113.

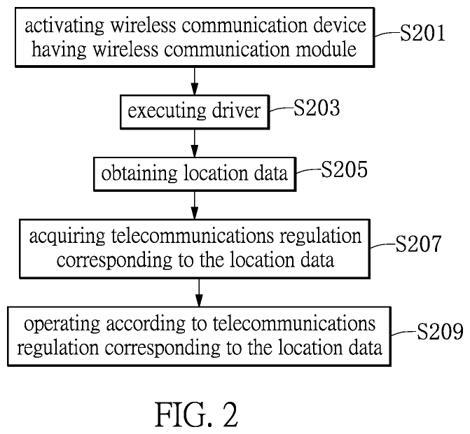

Reference is made to FIG. 2, which is a flowchart illustrating the method for acquiring the telecommunication regulations according to one embodiment of the present disclosure. Firstly, a wireless communication device that includes a wireless communication module and a driver installed with the wireless communication module is activated (step S201). Then, an operating system of the wireless communication device executes the driver for driving the wireless communication module (step S203). In the meantime, the driver obtains location data from a BIOS or the operating system, or through an environment detection process (step S205). The location data refers to data that can indicate a region or a country where the wireless communication device is operated. The location data allows the driver to compare with the telecommunication regulations written into the program codes of the driver, so as to obtain the telecommunication regulation corresponding to the location data (step S207). Every telecommunication regulation recorded in the program codes of the driver includes a channel plan, a physical layer (e.g., IEEE 802.11 PHY) configuration and a supervision standard that allow the system with the wireless communication module to be operated in accordance with the telecommunication regulation corresponding to the location data (step S209).

The driver of the wireless communication device can acquire the location and the corresponding communication regulation from outside of the wireless communication hardware module by a static check method or a dynamic check method. The target to be checked can be the operating system, a storage device and a communication device. After that, the wireless communication device can perform wireless transmission in accordance with the corresponding telecommunication regulation. The telecommunication regulation specifies the channel plan, the physical layer configuration and the supervision standard.

A first method for acquiring the information relating to the telecommunication regulation is to query the BIOS that is configured to store the regional information (such as an area code and a country code). The BIOS can be a system management BIOS (SMBIOS). The information of the BIOS is compared with the program codes of the driver, so as to acquire the corresponding regional telecommunication regulation. A storage format of the BIOS is exemplified in Table 1.

TABLE 1

| | | | | ISO | SAR |
|---|---|---|---|---|---|
| | | | | Country | Table |
| Type (1) | Length(1) | Handle(2) | Vendor(4) | Code(2) | (2) |
| 0xF8 | 0x0C | 0x0000 | 0x00E04C01 | 0x0XXX | 0xXXXX |

The fields in the storage format of the system management BIOS are described as follows.

An ISO Country Code can be the area code that is used to indicate a shipping region (e.g., a country) of a product. The country code can be represented by the ISO 3166-1 standard. The driver of the wireless communication device reads the country code for setting the corresponding channel plan, switches functions of IEEE802.11ac/11ax, and turns on or off an adaptivity function. According to a global default setting of the driver, the code “0x00” indicates the channel plan, the 11ac function and the adaptivity function. The ISO country code can be specified according to the ISO 3166-1 standard. For example, the country code of the United States is “0x0840”, the country code of Russia is “0x0643”, and the country code of Taiwan is “0x0158.”

A SAR Table specifies a specific absorption rate (SAR), which indicates a measurement value of an energy absorption rate when an object is exposed to an electromagnetic field. The SAR table is used to store a TX (transmission) power table index that is required for the product to pass an abortion rate test. The value in the SAR table corresponds to a TX power table in the driver. The driver can adjust the transmission power according to the TX power table corresponding to the SAR table. The value of the absorption rate can be determined by a manufacturer of the product when the adjustment of the transmission power is completed. The code “0x00” indicates that no transmission power is required to be adjusted.

A second method is to acquire the information relating to the region and the corresponding telecommunication regulation from the operating system. For example, in an operating system (WINDOWS®), the driver of the wireless communication device acquires location data via a system programming interface, and the location data can be set by a location of region and language in the operating system.

A third method is to acquire the information relating to the region and the corresponding telecommunication regulation by detecting the information retrieved from an access point (AP) in an environment. The access point can be any network device in a network system. For example, the network communication device 10 within a network environment scans the nearby access points 301, 302, 303, 304, 305 and 306 by a software means. Referring to an IEEE 802.11h protocol, the beacon signals broadcasted by the access points 301, 302, 303, 304, 305 and 306 may carry the searchable location data of an area or a country. The location data can be a country code. Therefore, the country code of where the network communication device 10 is located can be obtained by scanning the access points and retrieving a country information element in the beacon signals. Different ways may be used to scan the network device with different frequency bands in the environment. As shown in Table 2, an active way of scanning is used to scan the access points in the environment through 2.4 GHz channels 1 to 13, and a passive way of scanning is used to scan the access points in the environment through a 2 GHz channel 14 and through all 5 GHz channels. When the beacon signals in most of the access points in the environment are collected, a specific country code and a corresponding communication regulation can be set by different strategies according to the location data retrieved from the beacon signals of the access points.

TABLE 2
examples of the frequency bands and the
corresponding ways to scan the channels.

| | active scan | passive scan |
|---|---|---|
| frequency band | channels | channels |
| 2.4 G | 1, 2, 3, 4, 5, 6, 7, | 14 |
| | 8, 9, 10, 11, 12, 13 | |
| 5 G | None | 36, 40, 44, 48, |
| | | 52, 56, 60, 64, |
| | | 100, 104, 108, 112, |
| | | 116, 120, 124, 128, |
| | | 132, 136, 140, 144, |
| | | 149, 153, 157, 161, 165 |

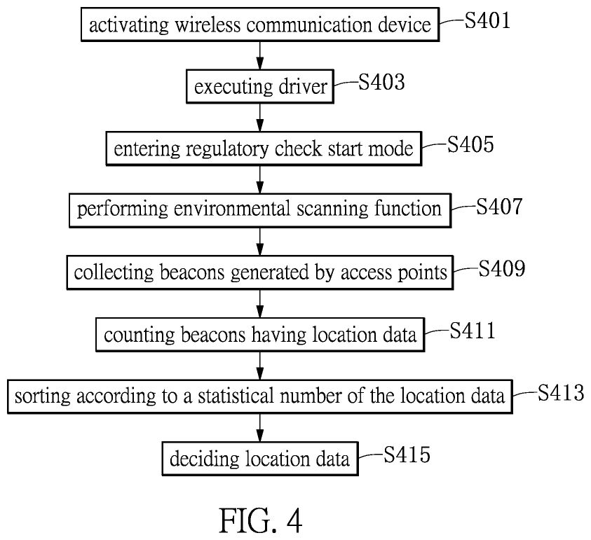

In an exemplary example, reference is made to FIG. 4, which is a flowchart illustrating the method for acquiring the telecommunication regulations. The region (e.g., a country code) where the wireless communication device is located and the telecommunication regulation corresponding to the location can be determined according to the beacon signals broadcasted by the access points in the environment. It should be noted that the telecommunication regulation can be the supervision standard for wireless transmission.

When the wireless communication device is activated (step S401), an operating system is operated and performs a driver installed in the operating system (step S403). Apart from the wireless communication module being driven by the driver, the operating system relies on the driver to scan the environment for retrieving the information relating to a region and a supervision standard through a specific source. In addition, the operating system enters a regulatory check start mode after acquiring the telecommunication regulation (step S405), and the wireless communication module in the wireless communication device is driven by the driver to perform an environmental scanning function (step S407). The wireless communication module starts scanning the access points in the environment through the active scan channels (2.4 GHz) and the passive scan channels (5 GHz) according to Table 2. The beacon signals broadcasted by every access point are collected (step S409) according to an instruction (e.g., “collect AP beacons”).

After the environment is scanned (with an instruction of “scan complete” being generated), in response to an instruction of “country code statistics”, a statistical analysis is performed on the beacon signals having information of the location data (e.g., an area code or a country code) through a software operated in the operating system of the wireless communication device (step S411). Then, a statistical number is referred to for sorting the location data. The location data can be sorted from most to least based on a quantity of each piece of the location data (step S413). A customized strategy can be adopted according to the need of each client, so as to select a final region and a telecommunication regulation corresponding to the location data retrieved from the program codes of the driver. For example, the location data with the largest quantity can be selected according to a statistical result, or the location data can be decided according to a specific selection strategy (step S415). The location and the corresponding telecommunication regulation are stored in a memory of the wireless communication device. Finally, this regulatory check process of determining the location data and the corresponding supervision standard for the wireless communication device is terminated.

According to the region and the corresponding supervision standard obtained from the above steps, before the next regulatory check process begins, the wireless communication device operates and performs wireless transmission based on the region and the supervision standard.

The following examples are given to illustrate the process of the method described above.

### EXAMPLE 1

One aspect of scanning the environment is to scan the system management BIOS of all of the access points. When the environment is completely scanned, a software procedure operated in a wireless communication device is used to count a quantity of the access points having different country codes. For example, a counting result indicates that there are 35 access points designated with the country code “TW”, 22 access points designated with the country code “US”, and 11 access points designated with the country code “CN.”

Afterwards, according to the customized strategy, a selection procedure is performed for the client to select the region and the corresponding telecommunication regulation. In the present example, several selection strategies are provided as follows.

Strategy A: the country with the largest quantity of country codes is selected. In the present example, the country code “TW” has the largest quantity according to the statistical result, and the wireless communication device operates wireless transmission in accordance with the telecommunication regulation in Taiwan (e.g., that of the National Communications Commission (NCC)).

Strategy B: the selection strategy mainly uses “US” as the selected country code for operation of the wireless communication device. As long as the country code “US” is present in the environment, the wireless communication device operates wireless transmission in accordance with the telecommunication regulation in the U.S. (e.g., that of the Federal Communications Commission (FCC)).

### EXAMPLE 2

When the environmental scanning is completed, a quantity of the country codes obtained from the access points in the environment is counted. One country code “TW” is obtained from one of the access points, and one country code “CN” is obtained from another one of the access points. In this example, no country code with the largest quantity can be selected, and the selection strategy will be as follows.

Strategy A: a default supervision standard (e.g., the NCC) can be used by the wireless communication device to perform wireless transmission accordingly.

Strategy B: a specific country code (e.g., “US”) can be predetermined as a default supervision standard, and the wireless communication device can operate in accordance with the Federal Communications Commission of the United States.

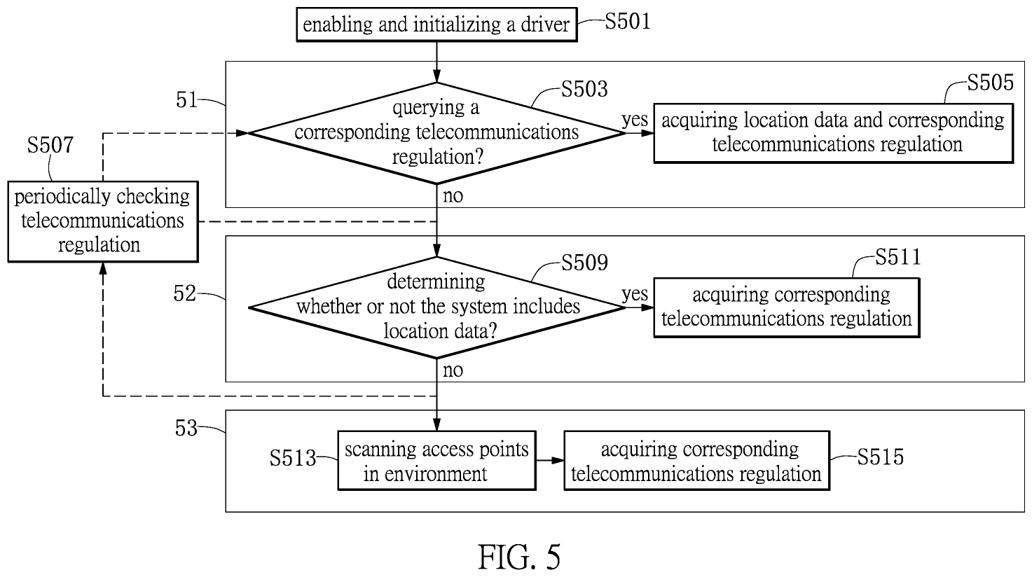

Through the method illustrated above, the region and the corresponding telecommunication regulation applied to the wireless communication device can be determined by a static check method or a dynamic check method (as required by the client) with use of a single stock keeping unit (SKU). In this way, the wireless communication device can operate in accordance with the telecommunication regulation. Reference is made to FIG. 5, which is a flowchart illustrating a main process of determining the region and the corresponding telecommunication regulation according to one embodiment of the present disclosure.

After the wireless communication device is activated, a driver is initialized (step S501). The process can be divided into three phases, which include a system SKU check phase 51, a supplementary check phase 52 and an environmental check phase 53. The system SKU check phase 51 belongs to a static check mechanism, and the supplementary check phase 52 and the environmental check phase 53 both belong to a dynamic check mechanism. It should be noted that a sequence of the above-mentioned phases is only an example, and should not be taken as limiting the sequence of acquiring the telecommunication regulation.

In one embodiment of the process, when the system enters the system SKU check phase 51, the BIOS of the wireless communication device is checked for determining whether or not any area code or country code with respect to location data is present. A corresponding telecommunication regulation can be acquired based on the above determination (step S503). If the area code or the country code is present, the region and the corresponding telecommunication regulation can be determined (step S505). According to one embodiment, when the area code and a specific absorption rate table (SAR table) are obtained, a transmission power table (TX power table) is further provided for the driver to adjust the transmission power of the wireless communication device, so that the wireless communication device can operate in accordance with the telecommunication regulation.

When the system is in the system SKU check phase 51 without acquiring the location data and the corresponding telecommunication regulation, the driver of the wireless communication device dynamically checks and decides the telecommunication regulation to be adopted by the wireless communication device every interval of time (step S507). The dynamic check mechanism can be performed in the supplementary check phase 52, and the driver of the wireless communication device retrieves the location data from the system information (e.g., a system registry key). The location data is, for example, country information of an operating system operated in the wireless communication device. In the process, whether or not the system information includes the location data is determined (step S509). When it is determined that the system information includes the location data, the corresponding telecommunication regulation is acquired (step S511). It should be noted that the driver can operate wireless transmission with the corresponding telecommunication regulation only if certain conditions (e.g., the corresponding country being the United States, Indonesia, etc.) are matched.

If the system fails to acquire the location data where the wireless communication device operates during the system SKU check phase 51 or the supplementary check phase 52, similarly, the driver dynamically checks and decides the telecommunication regulation to be adopted every interval of time (step S507). Next, the system enters the environmental check phase 53, in which the wireless communication device actively or passively scans the beacon signals generated by one or more access points in the environment through a software process in the driver (step S513). The system then determines if the location data with the largest quantity can be checked successfully. If the location data with the largest quantity is obtained successfully, the location data can be used to obtain the telecommunication regulation corresponding to an area code (step S515). Conversely, if no area code matching the conditions can be obtained, the driver drives the wireless communication device to perform wireless transmission according to a predetermined regulation.

According to the above flowchart of the embodiment, when the mobility of the wireless communication device is taken into consideration, the method is performed to periodically (e.g., every one hour) check the location data after entering the dynamic check mechanism. This means that the system periodically enters the supplementary check phase 52 or the environmental check phase 53, and performs wireless transmission according to the scanning result.

Wireless telecommunication regulations of each country are illustrated as follows.

The wireless communication regulation complied by the wireless communication device that adopts the IEEE 802.11 wireless network standard includes a channel plan, a physical layer configuration and a supervision standard. When the wireless communication device acquires the region and the corresponding telecommunication regulation through the method of the present disclosure, the telecommunication regulation can be followed in different modes according to different requirements. Several operating modes (from loose to strict) are provided below.

### Channel Mode

The channel mode provides a more lenient mechanism, so that more access points can be supported. Under the channel mode, the wireless communication device is allowed to establish connections and conduct transmission as long as the wireless communication device is within a spectrum permitted by a national communication regulation. The magnitude of transmission power and required supported functions (such as adaptivity and DFS master/slave) should comply with the telecommunication regulation of a specific region (e.g., the FCC or the NCC). In addition, transmission protocols for a spectrum should also comply with the corresponding regulations (e.g., IEEE 802.11 A/B/G/N/AC/AX). For example, the supervision standard followed by the wireless communication device with respect to the country code “US” is the FCC. However, when the country code of one of the access points is “DE” (Germany), the wireless communication device can still establish a connection and perform wireless transmission if the spectrum is supported by the FCC. In this case, only the FCC regulation needs to be followed (rather than the CE standard).

### Domain Mode

Under the domain mode, different countries with the same channel plan, the same wireless communication physical layer and the same supervision standard can be regarded as the same domain. When the domain is confirmed, the wireless communication device can only connect with the access point at the same domain and perform the transmission since the transmission power, the functions and the signal format should comply with the regional telecommunication regulation. For example, Austria (AT) and Belgium (BE) are regarded as the same domain and are required to comply with the CE standard. In the meantime, if the country code of one access point is “US”, the wireless communication device that operates with the CE standard cannot establish connection with said access point for belonging to different domains.

### Country Mode

The country mode is the strictest mode for the wireless communication device to operate. After the country code is defined, the wireless communication device can only connect with and perform transmission with the access point having the same country code. Similarly, all of the transmission power, the functions and the signal format between the wireless communication device and the access point that are required to be interconnected should comply with the telecommunication regulation of the same country code. For other access points having no country code or different country codes, no support can be provided, such that connection and transmission are not possible.

In summation, in the method for acquiring the telecommunication regulations and the system applying the same provided by the present disclosure, the system can achieve production and management of the wireless communication modules with the single SKU through the above process performed by the driver and according to various approaches of acquiring the national regulations and standard. In addition, hardware data of the wireless communication module no longer needs to be modified through a production line and the production program since only the driver will be updated when the regulation is required to be updated. Therefore, the system effectively simplifies the procedure of production management and has a good flexibility for determining and following an appropriate regulation under different circumstances.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for acquiring a telecommunication regulation, comprising:
executing a driver for driving a wireless communication module;
comparing, by the driver, location data to multiple ones of the telecommunication regulation recorded in program codes of the driver, so as to acquire the telecommunication regulation corresponding to the location data; and
operating a system having the wireless communication module according to the telecommunication regulation corresponding to the location data.

2. The method according to claim 1, wherein the location data includes a country code or an area code.

3. The method according to claim 2, wherein the location data is stored in a BIOS or in an operating system.

4. The method according to claim 2, wherein the system having the wireless communication module scans beacon signals generated by one or more access points to determine the location data.

5. The method according to claim 4, wherein the system scans the one or more access points with different frequency bands in an active manner or in a passive manner.

6. The method according to claim 5, wherein, when multiple pieces of the location data are obtained by scanning the beacon signals generated by the multiple access points, one of the multiple pieces of the location data is decided on via a statistical method.

7. The method according to claim 5, wherein, when multiple pieces of the location data are obtained by scanning the beacon signals generated by the multiple access points, one of the multiple pieces of the location data is decided on according to a selection strategy.

8. The method according to claim 1, wherein each of the telecommunication regulations recorded in the program codes of the driver includes a channel plan, a physical layer configuration and a supervision standard.

9. The method according to claim 8, wherein the telecommunication regulation further includes a transmission power of the wireless communication module, and the transmission power is adjusted by the driver.

10. A system applying a method for acquiring a telecommunication regulation, comprising:
a wireless communication module; and
a memory storing a driver for the wireless communication module and program codes;
wherein, when the system is activated, the driver is executed by an operating system for driving the wireless communication module to operate, and the driver is used to perform the method for acquiring the telecommunication regulation; wherein the driver uses location data to compare multiple ones of the telecommunication regulation recorded in the program codes of the driver for acquiring the telecommunication regulation corresponding to the location data, so that the system operates according to the telecommunication regulation corresponding to the location data.

11. The system according to claim 10, wherein the location data is stored in a BIOS or in the operating system, and the location data includes a country code or an area code.

12. The system according to claim 10, wherein the system having the wireless communication module scans beacon signals generated by one or more access points to determine the location data that includes a country code or an area code.

13. The system according to claim 12, wherein the system scans the one or more access points with different frequency bands in an active manner or in a passive manner.

14. The system according to claim 13, wherein, when multiple pieces of the location data are obtained by scanning the beacon signals generated by the multiple access points, one of the multiple pieces of the location data is decided on via a statistical method.

15. The system according to claim 13, wherein, when the multiple pieces of the location data are obtained by scanning the beacon signals generated by the multiple access points, one of the multiple pieces of the location data is decided on according to a selection strategy.

16. A method for acquiring telecommunication regulations, comprising:
activating a driver for driving a wireless communication module;
entering a system SKU check phase, wherein: a BIOS of a system is checked for determining whether or not location data is present, and in response to the location data being present in the BIOS, the corresponding telecommunication regulation is queried according to the location data;
entering a supplementary check phase when the location data is not present in the BIOS, wherein: system information of the system is checked for determining whether or not the location data is present, and in response to the location data being present in the system information, the corresponding telecommunication regulation is queried according to the location data;
entering an environmental check phase when the location data is not present in the system information, wherein: the driver scans beacon signals generated by one or more access points in an environment of the system in an active manner or in a passive manner for checking whether or not the location data is present in the beacon signals, and in response to the location data being present in the beacon signals, the corresponding telecommunication regulation is queried according to the location data; and
operating the system having the wireless communication module according to the telecommunication regulation corresponding to the location data.

17. The method according to claim 16, wherein, when the location data is determined not to be present in the system SKU check phase or the supplementary check phase, the driver periodically checks the location data in the system SKU check phase or the supplementary check phase.

18. The method according to claim 16, wherein, when multiple pieces of the location data are obtained by scanning the beacon signals generated by the multiple access points, one of the multiple pieces of the location data is decided on via a statistical method.

19. The method according to claim 18, wherein, when the multiple pieces of the location data are obtained by scanning the beacon signals generated by the multiple access points, one of the multiple pieces of the location data is decided on according to a selection strategy.

20. The method according to claim 16, wherein each of the telecommunication regulations recorded in the program codes of the driver includes a channel plan, a physical layer configuration and a supervision standard.
